(19) United States
(12) Patent Application Publication
(10) Pub. No.: US 2025/0292031 A1
(43) Pub. Date: Sep. 18, 2025

(54) INFORMATION PROCESSING APPARATUS, ANALYSIS METHOD, AND RECORDING MEDIUM

(71) Applicant: NEC Corporation, Tokyo (JP)

(72) Inventor: Naoki YOSHINAGA, Tokyo (JP)

(73) Assignee: NEC Corporation, Tokyo (JP)

(21) Appl. No.: 18/985,387

(22) Filed: Dec. 18, 2024

(30) Foreign Application Priority Data
Mar. 18, 2024 (JP) 2024-042644

(51) Int. Cl. G06F 40/40; G06Q 30/0201

(52) U.S. Cl. CPC G06F 40/40; G06Q 30/0201

(57) ABSTRACT

Various analysis targets can be efficiently analyzed. An information processing apparatus includes: a data acquiring section that acquires feature data indicating a feature of an analysis target; and a word or phrase acquiring section that uses the feature data to cause a language model that has been machine-learned to generate at least one appealing word or phrase indicating a point which the analysis target appeals to a predetermined target person, or that causes the language model to select one or more of candidates for the at least one appealing word or phrase, the one or more matching the feature data. This information processing apparatus makes it possible to support decision making by a user.

This Nonprovisional application claims priority under 35 U.S.C. § 119 on Patent Application No. 2024-042644 filed in Japan on Mar. 18, 2024, the entire contents of which are hereby incorporated by reference.

### TECHNICAL FIELD

The present disclosure relates to an information processing apparatus, an analysis method, and a recording medium.

### BACKGROUND ART

In the case of, for example, planning of a new product, trend analysis is frequently carried out with respect to, for example, existing hit products. Trend analysis is commonly carried out on the basis of experience and/or intuition of an analyst. Note, however, that a technique for automating trend analysis is also known. Examples of such a technique include a social networking service (SNS) image trend analysis system disclosed in Patent Literature 1.

### CITATION LIST

### Patent Literature

### [Patent Literature 1]

International Publication No. WO 2020/035934

### SUMMARY OF INVENTION

### Technical Problem

In the SNS image trend analysis system disclosed in Patent Literature 1, an image to which a specific hashtag is attached is extracted from an SNS to analyze a trend in the SNS from a relationship between a component of the image and a hashtag co-occurring in the image. However, the above SNS image trend analysis system has room for various improvements such as the fact that it is impossible to analyze, for example, an image to which no hashtag is attached.

The present disclosure has been made in view of the above problem, and an example object thereof is to provide a technique that makes it possible to efficiently analyze various analysis targets.

### Solution to Problem

An information processing apparatus in accordance with an example aspect of the present disclosure includes at least one processor, the at least one processor carrying out: a data acquiring process for acquiring feature data indicating a feature of an analysis target; and a word or phrase acquiring process for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.

An analysis method in accordance with an example aspect of the present disclosure includes: a data acquiring process for acquiring feature data indicating a feature of an analysis target; and a word or phrase acquiring process for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data, the data acquiring process and the word or phrase acquiring process each being carried out by at least one processor.

A recording medium in accordance with an example aspect of the present disclosure is a non-transitory computer-readable recording medium recording therein an analysis program for causing a computer to function as: a data acquiring means for acquiring feature data indicating a feature of an analysis target; and a word or phrase acquiring means for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.

### Advantageous Effects of Invention

An example aspect of the present disclosure brings about an example advantage of making it possible to efficiently analyze various analysis targets.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an analysis method in accordance with the present disclosure.

FIG. 3 is a block diagram illustrating a configuration of another information processing apparatus in accordance with the present disclosure.

FIG. 4 is a view illustrating example acquisition of a feature word or phrase and an appealing word or phrase.

FIG. 5 is a view illustrating an example of a graph showing an analysis result.

FIG. 6 is a flowchart illustrating a flow of processes carried out by the information processing apparatus illustrated in FIG. 3.

FIG. 7 is a block diagram illustrating a configuration of a computer that functions as the information processing apparatus in accordance with the present disclosure.

### EXAMPLE EMBODIMENTS

The following description will discuss example embodiments of the present invention. Note, however, that the present invention is not limited to the example embodiments described below, but can be altered in various ways by a skilled person in the art within the scope of the claims. For example, the present invention can also encompass, in its scope, any example embodiment derived by appropriately combining techniques (some or all of products or processes) employed in the example embodiments described below. Further, the present invention can also encompass, in its scope, any example embodiment derived by appropriately omitting some of the techniques employed in the example embodiments described below. Furthermore, the effects mentioned in the example embodiments described below are example effects expected in the example embodiments described below, and are not intended to define an extension of the present invention. That is, the present invention can also encompass, in its scope, any example embodiment that does not bring about any of the effects mentioned in the example embodiments described below.

### First Example Embodiment

The following description will discuss a first example embodiment, which is an example embodiment of the present invention, in detail with reference to the drawings. The present example embodiment is a basic form of example embodiments described later. Note that the scope of application of techniques which are employed in the present example embodiment is not limited to the present example embodiment. That is, the techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Information Processing Apparatus 1)

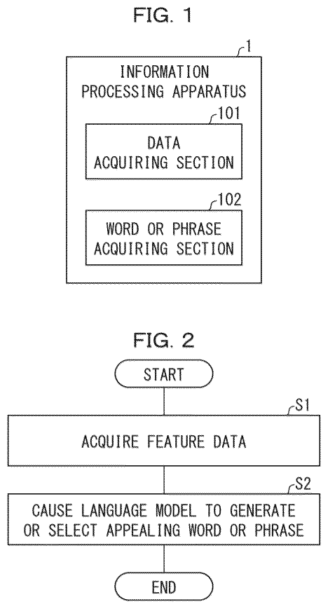

A configuration of an information processing apparatus 1 in accordance with the present example embodiment will be described with reference to FIG. 1. FIG. 1 is a block diagram illustrating the configuration of the information processing apparatus 1. As illustrated in FIG. 1, the information processing apparatus 1 includes a data acquiring section 101 and a word or phrase acquiring section 102.

The data acquiring section 101 acquires feature data indicating a feature of an analysis target. Note here that the “analysis target” is a target to be analyzed by the information processing apparatus 1. The information processing apparatus 1 may analyze any target. For example, the information processing apparatus 1 can also use any product and any service as the analysis target. Further, for example, the information processing apparatus 1 can also use any region, any person, any organization, and any group as the analysis target.

The “feature data” need only be data indicating the feature of the analysis target and may have any data format. For example, text data such as a word or phrase (a term consisting of one word or a phrase consisting of a plurality of words) or a document indicating a feature of a target may be used as the feature data, or an image indicating the feature of the analysis target may be used as the feature data. Alternatively, a graph or numerical data indicating the feature of the analysis target may be used as the feature data, or two or more of these data may be used as the feature data.

The word or phrase acquiring section 102 uses the feature data acquired by the data acquiring section 101 to cause a language model that has been machine-learned to generate at least one appealing word or phrase indicating a point which the analysis target appeals to a predetermined target person. Note here that the “appealing word or phrase” may be a term consisting of one word, or may be a phrase consisting of a plurality of words. Note also that an “appealing point” is a point which appeals to a target person, and can also be rephrased as a sense of value of a target person who selects the analysis target, or a point which the target person values. Thus, the “appealing word or phrase” can be rephrased as, for example, a word or phrase indicating a sense of value, a keyword indicating a sense of value, or a keyphrase indicating a sense of value.

Further, the “predetermined target person” is in accordance with the analysis target. For example, in a case where the analysis target is a product or service, the predetermined target person is a consumer of the product or service. Alternatively, for example, in a case where the analysis target is a tourist site, the predetermined target person is, for example, a visitor who visits the tourist site.

Further, the “language model” need only be machine-learned so as to be able to generate an appealing word or phrase indicating a point that an analysis target having a feature indicated by feature data appeals to a target person. For example, in a case where the feature data is text data, a model that has learned, by machine learning, an arrangement of components (such as words) of a sentence and an arrangement of sentences in text may be applied as the language model. Furthermore, for example, in a case where the feature data is image data, a model that has learned, by machine learning, a relationship between the image data and a word or phrase indicating a point which a target indicated by the image data appeals to a target person may be applied as the language model.

The word or phrase acquiring section 102 may acquire an appealing word or phrase by causing a language model that has been machine-learned to select one or more of candidates for the appealing word or phrase, the one or more matching the feature data acquired by the data acquiring section 101. In this case, the word or phrase acquiring section 102 need only input, into the language model, the candidates for the appealing word or phrase and the feature data acquired by the data acquiring section 101, and cause the language model to output one or more of the candidates, the one or more matching the feature data.

As described above, a configuration is employed such that the information processing apparatus 1 in accordance with an example embodiment of the present invention includes: the data acquiring section 101 that acquires feature data indicating a feature of an analysis target; and the word or phrase acquiring section 102 that uses the feature data acquired by the data acquiring section 101 to cause a language model that has been machine-learned to generate at least one appealing word or phrase indicating a point which the analysis target appeals to a predetermined target person, or that causes the language model to select one or more of candidates for the at least one appealing word or phrase, the one or more matching the feature data acquired by the data acquiring section 101.

It is important in analyzing an analysis target to understand the point which the analysis target appeals to a predetermined target person, but it is not necessarily possible for anyone to easily understand such a point. In this regard, according to the above configuration, merely by, for example, inputting feature data indicating a feature of an analysis target into the information processing apparatus 1 to cause the information processing apparatus 1 to acquire the feature data, a user of the information processing apparatus 1 can cause the information processing apparatus 1 to acquire an appealing word or phrase indicating the point which the analysis target appeals to a predetermined target person. Thus, the above configuration brings about an effect of making it possible to efficiently analyze various analysis targets.

Further, since the appealing word or phrase is a word or phrase indicating the point which the analysis target appeals to a predetermined target person, it can be said that the appealing word or phrase is useful in a case where the user makes decision on the analysis target. Thus, the above configuration also makes it possible to support decision making by the user. Assume, for example, that the information processing apparatus 1 is used for product development. In this case, by using, as an analysis target, an existing product related to a product that is desired to be developed or an existing hit product, it is possible to cause the information processing apparatus 1 to acquire an appealing word or phrase indicating a point which the analysis target appeals to a consumer. With reference to the acquired appealing word or phrase, the user can determine an element to be introduced into a product to be developed.

Further, a configuration in which a language model that has been machine-learned is caused to select one or more of the candidates for the appealing word or phrase, the one or more matching the feature data acquired by the data acquiring section 101 also has an advantage of making it possible to avoid a complicated analysis result. That is, in, for example, a case where appealing words or phrases are repeatedly acquired for an identical analysis target, or a case where appealing words or phrases are acquired for a respective plurality of analysis targets, it is assumed that an analysis result is complicated due to divergence of a total number of appealing words or phrases acquired. In this regard, since a total number of appealing words or phrases acquired is less likely to diverge in a case where the language model is caused to select an appealing word or phrase from among the candidates, it is possible to avoid a complicated analysis result.

### (Analysis Program)

The foregoing functions of the information processing apparatus 1 can also be realized by a program. An analysis program in accordance with an example embodiment of the present invention causes a computer to function as: a data acquiring means for acquiring feature data indicating a feature of an analysis target; and a word or phrase acquiring means for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data. This analysis program makes it possible to efficiently analyze various analysis targets.

### (Flow of Analysis Method)

A flow of an analysis method in accordance with the present example embodiment will be described below with reference to FIG. 2. FIG. 2 is a flowchart illustrating the flow of the analysis method. Note that steps of the analysis method may be carried out by a processor of the information processing apparatus 1 or by a processor of another apparatus. Alternatively, the steps may be carried out by processors provided in respective different apparatuses.

In S1 (a data acquiring process), at least one processor acquires feature data indicating a feature of an analysis target.

In S2 (a word or phrase acquiring process), the at least one processor uses the feature data acquired in S1 to cause a language model that has been machine-learned to generate at least one appealing word or phrase indicating a point which the analysis target appeals to a predetermined target person. Alternatively, in S2, the at least one processor causes the language model that has been machine-learned to select one or more of candidates for the at least one appealing word or phrase, the one or more matching the feature data acquired in S1.

As described above, a configuration is employed such that an analysis method in accordance with the present example embodiment includes: a data acquiring process for acquiring feature data indicating a feature of an analysis target; and a word or phrase acquiring process for using the acquired feature data to cause a language model that has been machine-learned to generate at least one appealing word or phrase indicating a point which the analysis target appeals to a predetermined target person, or for causing the language model that has been machine-learned to select one or more of candidates for the at least one appealing word or phrase, the one or more matching the acquired feature data, the data acquiring process and the word or phrase acquiring process each being carried out by at least one processor. Thus, the analysis method in accordance with the present example embodiment makes it possible to efficiently analyze various analysis targets.

### Second Example Embodiment

The following description will discuss a second example embodiment, which is an example embodiment of the present invention, in detail with reference to the drawings. Members having functions identical to those of the respective members described in the foregoing example embodiment are given respective identical reference numerals, and a description of those members is omitted as appropriate. Note that the scope of application of techniques which are employed in the present example embodiment is not limited to the present example embodiment. That is, the techniques which are employed in the present example embodiment can be employed also in the other example embodiments included in the present disclosure, provided that no particular technical problem occurs. Moreover, techniques which are indicated in the drawings referred to for describing the present example embodiment can be employed also in the other example embodiments included in the present disclosure, provided that no particular technical problem occurs.

### (Configuration of Information Processing Apparatus 1A)

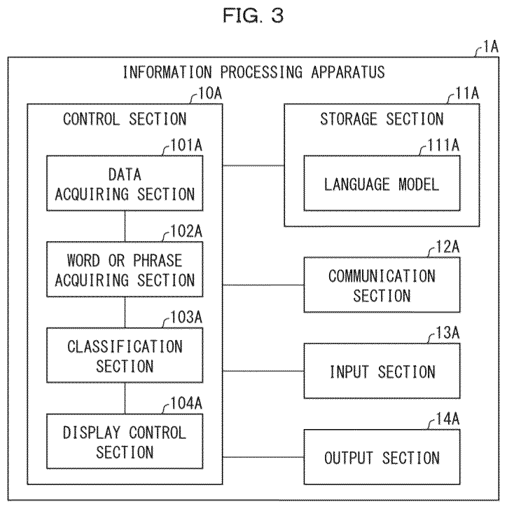

A configuration of an information processing apparatus 1A in accordance with the present example embodiment will be described below with reference to FIG. 3. FIG. 3 is a block diagram illustrating the configuration of the information processing apparatus 1A. The information processing apparatus 1A is an apparatus having a function of supporting analysis of a predetermined analysis target. The information processing apparatus 1A may analyze any target as in the case of the first example embodiment. The information processing apparatus 1A may be an apparatus whose main function is analysis support, or may be a general-purpose apparatus which includes other functions. The information processing apparatus 1A may be a stationary apparatus or a portable apparatus.

As illustrated in FIG. 3, the information processing apparatus 1A includes a control section 10A that collectively controls sections of the information processing apparatus 1A and a storage section 11A that stores various kinds of data used by the information processing apparatus 1A. The information processing apparatus 1A further includes a communication section 12A that allows the information processing apparatus 1A to communicate with another apparatus, an input section 13A that receives input to the information processing apparatus 1A, and an output section 14A that allows the information processing apparatus 1A to output data. The control section 10A includes a data acquiring section 101A, a word or phrase acquiring section 102A, a classification section 103A, and a display control section 104A. The storage section 11A stores a language model 111A. Note that the classification section 103A will be described in the section “Classification of appealing word or phrase” described later.

As in the case of the data acquiring section 101 of the first example embodiment, the data acquiring section 101A acquires feature data indicating a feature of an analysis target. The following description will discuss an example in which the data acquiring section 101A acquires, as the feature data, a feature word or phrase that is included in a document describing the analysis target and that indicates the feature of the analysis target. Note that a method for acquiring the feature word or phrase will be described in the section “Method for acquiring feature word or phrase” described later.

As in the case of the word or phrase acquiring section 102 of the first example embodiment, the word or phrase acquiring section 102A uses the feature data acquired by the data acquiring section 101A to acquire an appealing word or phrase. Specifically, the word or phrase acquiring section 102A causes the language model 111A to generate an appealing word or phrase indicating a point which the analysis target appeals to a predetermined target person. Alternatively, the word or phrase acquiring section 102A causes the language model 111A to select one or more of candidates for the appealing word or phrase, the one or more matching the feature data acquired by the data acquiring section 101A. Note that a more specific method for acquiring an appealing word or phrase will be described in the section “Method for acquiring appealing word or phrase” described later.

The language model 111A is a machine-learned model that has been machine-learned so as to be able to generate an appealing word or phrase indicating a point which an analysis target having a feature indicated by feature data appeals to a target person. More specifically, the language model 111A is a language model that has learned, by machine learning, an arrangement of components (such as words) of a sentence and an arrangement of sentences in text.

Note that the information processing apparatus 1A does not necessarily need to include the language model 111A, but may use the language model 111A stored in an apparatus external to the information processing apparatus 1A. In this case, the word or phrase acquiring section 102A instructs an external apparatus including the language model 111A to generate or select an appealing word or phrase, and acquires, from the external apparatus, the appealing word or phrase generated or selected by the external apparatus with use of the language model 111A.

The display control section 104A displays, on a display apparatus, information for supporting analysis of the analysis target. For example, the display control section 104A may display, on the display apparatus, the appealing word or phrase acquired by the word or phrase acquiring section 102A. Although details will be described later, the display control section 104A may alternatively display the appealing word or phrase in graph form. The display apparatus may be included in the information processing apparatus 1A or may be an apparatus external to the information processing apparatus 1A. For example, in a case where the output section 14A is used as the display apparatus, the display control section 104A may cause the output section 14A to display and output an analysis result.

As described above, a configuration is employed such that the information processing apparatus 1A in accordance with an example embodiment of the present invention includes: the data acquiring section 101A that acquires feature data indicating a feature of an analysis target; and the word or phrase acquiring section 102A that uses the feature data acquired by the data acquiring section 101A to cause the language model 111A that has been machine-learned to generate at least one appealing word or phrase indicating a point which the analysis target appeals to a predetermined target person, or that causes the language model 111A to select one or more of candidates for the at least one appealing word or phrase, the one or more matching the feature data acquired by the data acquiring section 101A. This brings about an effect of making it possible to efficiently analyze various analysis targets.

The information processing apparatus 1A is applicable to, for example, finding and interpretation of a sense of value of a consumer, and support for product concept idea generation. Thus, the information processing apparatus 1A is suitably applicable to, for example, information analysis during planning of a new product or planning for renewal of an existing product. For example, using the information processing apparatus 1A makes it possible to find a product of another company which product shares a sense of value with a product of a company. Further, using the information processing apparatus 1A also makes it possible to find another sense of value that the found product of the another company has. Such a finding can be a hint for devising a new product that can compete with a product of another company. Thus, the appealing word or phrase generated or selected by the information processing apparatus 1A may support decision making on product development.

### (Method for Acquiring Feature Word or Phrase)

As described earlier, the data acquiring section 101A acquires, as the feature data, a feature word or phrase that is included in a document describing the analysis target and that indicates the feature of the analysis target. For example, the data acquiring section 101A may specify, by morphologically analyzing the document describing the analysis target, the feature word or phrase that indicates the feature of the analysis target, and may acquire the specified feature word or phrase as the feature data. Note that the document describing the analysis target may be any document, examples of which include a document posted on a website introducing the analysis target and a document describing a user's review of the analysis target.

The data acquiring section 101A may cause the language model 111A to extract the feature word or phrase from the document describing the analysis target. In this case, the data acquiring section 101A generates a prompt which instructs the language model 111A to extract, from the document describing the analysis target, the feature word or phrase that indicates the feature of the analysis target, and inputs the generated prompt and the document into the language model 111A. Thus, the feature word or phrase is output from the language model 111A.

The above prompt may be generated by, for example, inputting a name of an analysis target into an {analysis target} part of a template “Please extract, from an input document, a word or phrase indicating a feature of {analysis target}.”. Such a template need only be stored in advance in, for example, the storage section 11A. Same applies to another template described later.

The data acquiring section 101A may use, as it is as the feature word or phrase (feature data), a word or phrase extracted from the document describing the analysis target. Alternatively, the data acquiring section 101A may present extracted words or phrases to a user of the information processing apparatus 1A and cause the user to select one or more of the presented words or phrases, the one or more being to be the feature word or phrase. For example, the data acquiring section 101A may display the extracted words or phrases on the display apparatus via the display control section 104A and may cause the user to select one or more of the displayed words or phrases, the one or more being to be the feature word or phrase.

As described above, the data acquiring section 101A may acquire, as the feature data, the feature word or phrase that is included in the document describing the analysis target and that indicates the feature of the analysis target. In this case, the word or phrase acquiring section 102A inputs the feature word or phrase into the language model 111A to cause the language model 111A to generate an appealing word or phrase. Alternatively, the word or phrase acquiring section 102A inputs the acquired feature word or phrase and candidates for the appealing word or phrase into the language model 111A to cause the language model 111A to select, as the appealing word or phrase, one or more of the input candidates, the one or more matching the input feature word or phrase. This brings about not only the effect brought about by the information processing apparatus 1 but also an effect of making it possible to acquire an appealing word or phrase from a document describing an analysis target.

The data acquiring section 101A can also generate a feature word or phrase from image data indicating a feature of an analysis target. For example, the data acquiring section 101A can also generate a feature word or phrase by inputting, into a language model that has learned, by machine learning, a relationship between the image data and a word or phrase indicating a feature of an analysis target which feature is indicated by the image data, the image data indicating the feature of the analysis target. By using such a language model, the data acquiring section 101A can generate a feature word or phrase such as “spicy” from, for example, image data imaging Chinese noodles in deep red soup.

Thus, the data acquiring section 101A may generate, from an image indicating an analysis target, a feature word or phrase indicating a feature of the analysis target, and acquire the feature word or phrase as the feature data. In this case, the word or phrase acquiring section 102A inputs the acquired feature word or phrase into the language model 111A to cause the language model 111A to generate an appealing word or phrase. Alternatively, the word or phrase acquiring section 102A inputs the acquired feature word or phrase and candidates for the appealing word or phrase into the language model 111A to cause the language model 111A to select, as the appealing word or phrase, one or more of the input candidates, the one or more matching the input feature word or phrase. This brings about not only the effect brought about by the information processing apparatus 1 but also an effect of making it possible to acquire an appealing word or phrase from an image indicating an analysis target.

### (Method for Acquiring Appealing Word or Phrase)

As described earlier, the word or phrase acquiring section 102A may cause the language model 111A to generate an appealing word or phrase, or may input candidates for the appealing word or phrase into the language model 111A to cause the language model 111A to select one or more of the input candidates, the one or more being to be the appealing word or phrase. Specifically, by generating a prompt for causing the language model 111A to select or generate an appealing word or phrase and inputting the prompt into the language model 111A, the word or phrase acquiring section 102A can cause the language model 111A to generate or select the appealing word or phrase.

A prompt for causing the language model 111A to generate an appealing word or phrase can be generated with use of, for example, a template “Please explain a point that a feature {feature word or phrase} of {analysis target} appeals to a consumer.”. In this case, by inputting a name of an analysis target into an {analysis target} part of the template and inputting a feature word or phrase into a {feature word or phrase} part of the template, the word or phrase acquiring section 102A can generate the prompt for causing the language model 111A to generate an appealing word or phrase.

A prompt for causing the language model 111A to select an appealing word or phrase can be generated with use of, for example, a template “Please select, from a list, an appropriate point as a point that a feature {feature word or phrase} of {analysis target} appeals to a consumer.”. In this case, by inputting a name of an analysis target into an {analysis target} part of the template and inputting a feature word or phrase into a {feature word or phrase} part of the template, the word or phrase acquiring section 102A can generate the prompt for causing the language model 111A to select an appealing word or phrase. The word or phrase acquiring section 102A need only input, together with the prompt, a list including words or phrases serving as candidates for the appealing word or phrase.

Note that, in a case where there is no appropriate word or phrase in the candidates, the language model 111A may be caused to generate a new appealing word or phrase. In this case, if there is no appropriate word or phrase in the candidates, the word or phrase acquiring section 102A need only input, into the language model 111A, a prompt that instructs the language model 111A to generate a new appealing word or phrase. For example, the word or phrase acquiring section 102A may input, into the language model 111A, the following prompt: “Please select, from a list, an appropriate point as a point that a feature {feature word or phrase} of {analysis target} appeals to a consumer. However, in a case where there is no appropriate point, please generate a word or phrase indicating a point that a feature {feature word or phrase} of {analysis target} appeals to a consumer.”

Further, instead of inputting the feature word or phrase into the language model 111A, into the language model 111A, the word or phrase acquiring section 102A may input, as feature data, a document describing the analysis target. Also in this case, a prompt as described earlier can be used to cause the language model 111A to generate or select an appealing word or phrase.

Candidates for the appealing word or phrase may be determined in advance. In this case, since the appealing word or phrase is selected in a predetermined range of candidates, it is possible to avoid divergence of a total number of appealing words or phrases. In particular, in a case where products or services having various attributes are cross-sectionally analyzed, an appealing point (appealing word or phrase) of the is products or services having different attributes selected from d candidates. This provides an advantage of allowing the products or services having different attributes to be linked together by a shared appealing word or phrase. Note here that the term “attribute” is a feature or property possessed by an analysis target such as a product or service. It can be determined as appropriate on the basis of what attribute to analyze an analysis target. For example, a genre, a category, or the like of a product or service can be defined as the “attribute”.

Further, for each analysis target included in some of groups consisting of analysis targets that share an attribute, an appealing word or phrase generated or selected by the language model 111A may be a candidate. This makes it possible to use an appealing word or phrase in some groups to indicate an appealing point of an analysis target in other groups.

For example, in a case where the analysis target is a product, an attribute such as “food”, “clothing”, or “daily goods” may be associated with each product to be analyzed. In this case, the word or phrase acquiring section 102A may cause the language model 111A to generate an appealing word or phrase for each product with which, for example, the attribute “food” among these attributes is associated. For each product with which the attribute different from “food” is associated, the word or phrase acquiring section 102A may cause the language model 111A to select an appealing word or phrase from among appealing words or phrases generated for respective products with which the attribute “food” is associated. Thus, the appealing words or phrases generated for the respective products with which the attribute “food” is associated can be used to indicate an appealing point of an analysis target having another attribute.

### (Example Acquisition of Feature Word or Phrase and Appealing Word or Phrase)

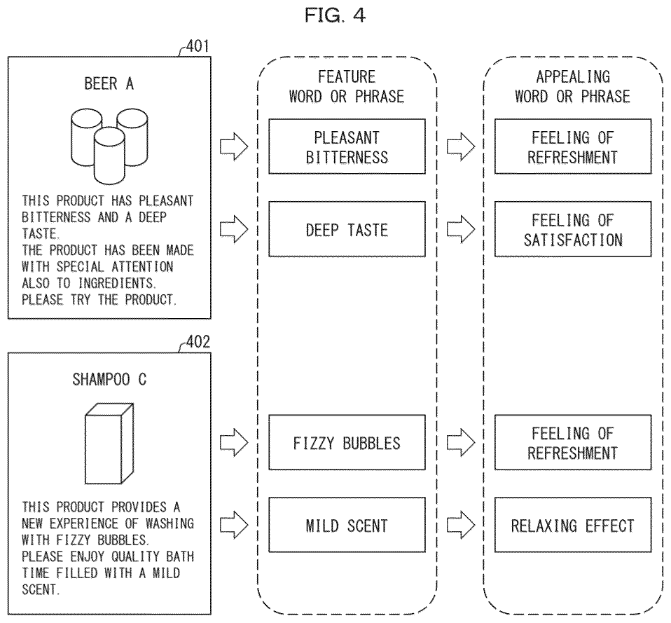

FIG. 4 is a view illustrating example acquisition of a feature word or phrase and an appealing word or phrase. FIG. 4 illustrates an example in which a feature word or phrase and an appealing word or phrase are acquired from each of a document 401 describing “beer A” and a document 402 describing a “shampoo C”. The document 401 may be, for example, a web page introducing the beer A. The document 401 can be, for example, a document in which a review of a person who drinks the beer A is provided. Same applies to the document 402.

In the example of FIG. 4, the data acquiring section 101A acquires, as the feature word or phrase, a word or phrase “pleasant bitterness” and a word or phrase “deep taste” that are included in the document 401. The word or phrase acquiring section 102A uses the appealing word or phrase “pleasant bitterness” to acquire an appealing word or phrase “feeling of refreshment”, and uses the feature word or phrase “deep taste” to acquire an appealing word or phrase “feeling of satisfaction”.

These appealing words or phrases each indicate a point that the beer A appeals to a consumer of the beer A, in other words, a sense of value that the consumer of the beer A has about the beer A, and are information useful in, for example, marketing but are not included in the document 401. The user of the information processing apparatus 1A can acquire such useful information merely by inputting the document 401 into the information processing apparatus 1A.

Further, in the example of FIG. 4, the data acquiring section 101A acquires, as the feature word or phrase, a word or phrase “fizzy bubbles” and a word or phrase “mild scent” that are included in the document 402. The word or phrase acquiring section 102A uses the appealing word or phrase “fizzy bubbles” to acquire an appealing word or phrase “feeling of refreshment”, and uses the feature word or phrase “mild scent” to acquire an appealing word or phrase “relaxing effect”.

In the example of FIG. 4, the appealing word or phrase “feeling of refreshment” is an appealing word or phrase acquired in both the beer A and the shampoo C. Thus, the word or phrase acquiring section 102A can also acquire a shared appealing word or phrase for products having different attributes, i.e., the beer A and the shampoo C. It is understood from this that “feeling of refreshment” is a point which appeals to a consumer across attributes of products.

### (Example of Graph)

The display control section 104A may cause a display apparatus to display, as an analysis result for an analysis target, a graph in which (a) a node indicating the analysis target and (b) a node indicating an appealing word or phrase generated or selected for the analysis target are connected by an edge. This brings about not only the effect brought about by the information processing apparatus 1 but also an effect of allowing the analysis result to be presented to a user in an intuitively easy-to-understand manner.

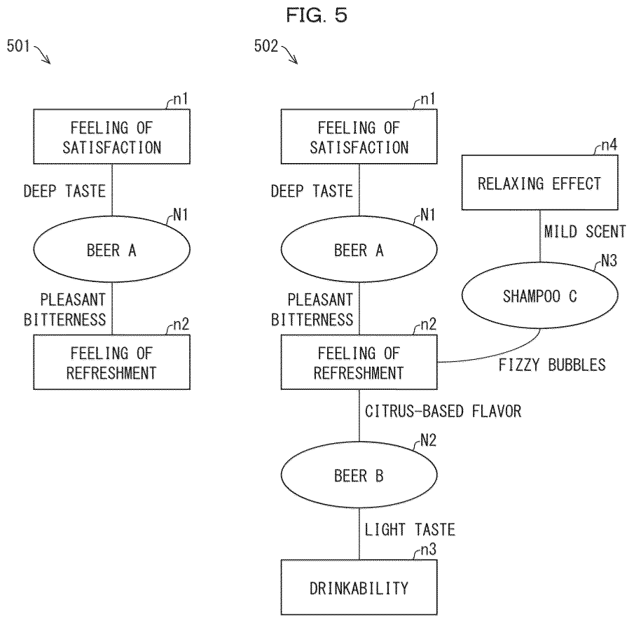

FIG. 5 is a view illustrating an example of a graph showing an analysis result. Specifically, a graph 501 illustrated in FIG. 5 shows an analysis result for the “beer A” illustrated in FIG. 4. The graph 501 includes a node N1 that indicates the beer A serving as an analysis target and nodes n1 and n2 that indicate the respective appealing words or phrases “feeling of refreshment” and “feeling of satisfaction” which have been generated for the beer A.

Further, in the graph 501, the node N1 and the nodes n1 and n2 are connected by edges. This makes it possible to recognize, at a glance, that points which the beer A appeals to a consumer are a feeling of satisfaction and a feeling of refreshment.

Furthermore, in the graph 501, the word or phrase “deep taste” is displayed in association with an edge connecting the node N1 and the node n1. This word or phrase is the feature word or phrase of the beer A which feature word or phrase has been acquired from the document 401 of FIG. 4, and is a word or phrase from which the appealing word or phrase “feeling of satisfaction” originates. Similarly, in the graph 501, the word or phrase “pleasant bitterness” is displayed in association with an edge connecting the node N1 and the node n2. This word or phrase is the feature word or phrase of the beer A which feature word or phrase has been acquired from the document 401 of FIG. 4, and is a word or phrase from which the appealing word or phrase “feeling of refreshment” originates.

Thus, the display control section 104A may cause a feature word or phrase from which an appealing word or phrase originates to be displayed in association with the appealing word or phrase. This allows the user to recognize what appealing word or phrase has been generated or selected from what feature word or phrase. The user can not only carry out analysis also in consideration of a feature word or phrase but also confirm whether an appropriate appealing word or phrase has been generated or selected.

In a case where the information processing apparatus 1A is used for marketing, it is preferable that a plurality of products or services be to be analyzed and that an appealing word or phrase be acquired for each h analysis target. This allows products or services that share an appealing word or phrase to be displayed in association with each other.

For example, in a case where an appealing word or phrase acquired for a certain analysis target is selected, the display control section 104A may cause another analysis target for which the same appealing word or phrase has been acquired to be displayed. This allows the user to recognize any other analysis target that has an appealing point on which the user focuses.

Further, in a case where another appealing word or phrase has been acquired for the another analysis target, the display control section 104A may also cause the another appealing word or phrase to be displayed. This makes it possible to present, to the user, further information that can be referred to in, for example, marketing.

Assume, for example, that an operation to select the node n2 has been carried out in the graph 501. In this case, the display control section 104A may cause a graph 502 illustrated in FIG. 5 to be displayed. The graph 502 includes nodes N2, N3, n3, and n4 in addition to the nodes N1, n1, and n2 that are included in the graph 501.

The node N2 is a node indicating “beer B”, which is one of analysis targets. To the node N2, the node n2 of the appealing word or phrase “feeling of refreshment” and the node n3 of an appealing word or phrase “drinkability” are each connected by a corresponding edge. Further, a feature word or phrase “citrus-based flavor” is displayed in association with an edge connecting the nodes N2 and n2, and a feature word or phrase “light taste” is displayed in association with an edge connecting the nodes N2 and n3.

Further, the node N3 is a node indicating the “shampoo C”, which is one of the analysis targets. To the node N3, the node n2 of the appealing word or phrase “feeling of refreshment” and the node n4 of the appealing word or phrase “relaxing effect” are each connected by a corresponding edge. Further, the feature word or phrase “fizzy bubbles” is displayed in association with an edge connecting the nodes N3 and n2, and the feature word or phrase “mild scent” is displayed in association with an edge connecting the nodes N3 and n4.

From the graph 502, the user can easily understand that products having an appealing point which is a feeling of refreshment include a product having a further appealing point such as a feeling of satisfaction, drinkability, or a relaxing effect. For example, during development of a new product or renewal of an existing product, such information is useful in considering what an appealing point of such a product will be. In particular, ordinary analysis makes it difficult to be aware of an appealing point that is shared by products having different attributes, such as beer and a shampoo. Note, however, that the information processing apparatus 1A makes it possible to give awareness of such an appealing point.

For example, the nodes n2 and n4 being connected to the node N3 suggest that a combination of a feeling of refreshment and a relaxing effect increases an effect of appealing to the user. For this reason, the user who is considering renewing the beer A can consider renewal such that a new appealing point which is a relaxing effect is added in addition to the appealing points which are possessed by the existing beer A, i.e., a feeling of satisfaction and a feeling of refreshment. The appealing word or phrase thus can also be used to support product concept idea generation.

### (Classification of Appealing Word or Phrase)

As in the examples of FIGS. 4 and 5, it is preferable to be able to acquire an appealing word or phrase shared for analysis targets having different attributes. However, in a case where the analysis targets have different attributes, feature words or phrases are frequently words or phrases that are in accordance with the attributes. Thus, appealing words or phrases are also highly likely to be words or phrases different from each other in accordance with the attributes. Further, even in a case where the analysis targets have an identical attribute, there are various documents describing those analysis targets. Thus, acquisition of various feature words or phrases and consequent acquisition of various appealing words or phrases may result in a complicated analysis result.

In this regard, the information processing apparatus 1A includes the classification section 103A that classifies, in accordance with content of an appealing word or phrase, a plurality of appealing words or phrases acquired by the word or phrase acquiring section 102A. The display control section 104A displays, in each of nodes corresponding to the respective appealing words or phrases that fall under an identical classification, a representative word or phrase which represents each of the appealing words or phrases that fall under the identical classification. This brings about not only the effect brought about by the information processing apparatus 1 but also an effect of making it possible to present an analysis result in a comprehensible manner even in a case where various appealing words or phrases have been acquired.

The appealing words or phrases may be classified by any method that is not particularly limited. For example, the classification section may vectorize appealing words or phrases to be classified, and calculate similarity between the vectorized appealing words or phrases. In this case, the classification section 103A need only classify, as an identical group, appealing words or phrases whose calculated similarity is not less than a predetermined threshold value.

Further, the classification section 103A may cause the language model 111A to output similarity between appealing words or phrases. In this case, the classification section 103A need only generate a prompt that instructs the language model 111A to output the similarity between the appealing words or phrases, and input the prompt into the language model 111A. Such a prompt can be generated by, for example, inputting, into respective {appealing word or phrase} parts of a template “Please express similarity between {appealing word or phrase} and {appealing word or phrase} in a numerical range from 0 to 1.”, the appealing words or phrases for which similarity is to be determined. Note that the numerical range can be arbitrarily set.

Furthermore, the classification section 103A may cause the language model 111A to determine whether the appealing words or phrases are similar. In this case, the classification section 103A need only generate a prompt that instructs the language model 111A to determine whether the appealing words or phrases are similar, and input the prompt into the language model 111A. Such a prompt can be generated by, for example, inputting, into respective {appealing word or phrase} parts of a template “Please answer “YES” in a case where {appealing word or phrase} and {appealing word or phrase} are similar, and answer “NO” in a case where {appealing word or phrase} and {appealing word or phrase} are dissimilar.”, the appealing words or phrases for which similarity is to be determined. Note that a result of determination of similarity may be output in any form.

Moreover, the classification section 103A may cause the language model 111A to classify the appealing words or phrases. In this case, the classification section 103A need only generate a prompt that instructs the language model 111A to classify the appealing words or phrase, and input, into the language model 111A, the prompt together with a list of appealing words or phrases to be classified. Such a prompt may be, for example, a template such as “Please classify words or phrases in the list in accordance with their content.”.

Note that a representative word or phrase of each classification need only be a word or phrase indicating each appealing word or phrase of the classification, and may be determined by any method. For example, the display control section 104A may regard, as the representative word or phrase of the classification, one appealing word or phrase selected from among appealing words or phrases that fall under an identical classification. Further, for example, the display control section 104A may cause a user to input the representative word or phrase. Furthermore, for example, the display control section 104A may input, into the language model 111A, a list of appealing words or phrases that fall under an identical classification, cause the language model 111A to output a generic term for those words or phrases, and regard the output generic term as the representative word or phrase.

### (Flow of Processes)

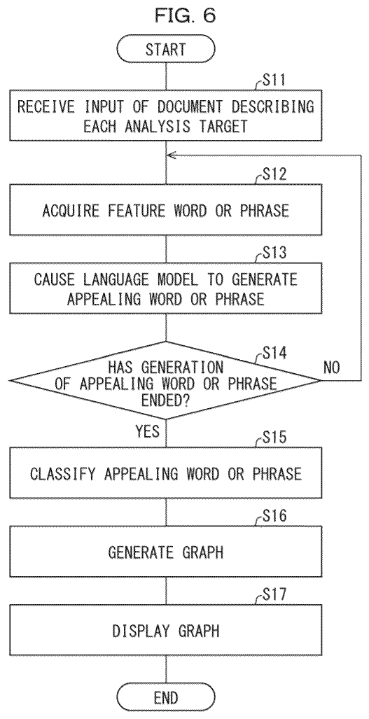

A flow of processes carried out by the information processing apparatus 1A will be described below with reference to FIG. 6. FIG. 6 is a flowchart illustrating the flow of the processes carried out by the information processing apparatus 1A. The flow of FIG. 6 includes steps of the analysis method in accordance with the present example embodiment.

In S11, the data acquiring section 101A receives input of a document describing each analysis target. The document may be input by any method. For example, the data acquiring section 101A may receive input of the document via the input section 13A or may receive input of the document via the communication section 12A. Alternatively, the data acquiring section 101A may receive, instead of or together with the document describing the analysis target, input of an image indicating the analysis target.

Note that, in S11, instead of receiving the input of the document, the data acquiring section 101A may receive specification of an attribute to be analyzed. In this case, the data acquiring section 101A may search for (i) a document describing a product, service, or the like having the input attribute and/or (ii) an image related to the product, service, or the like. Then, the data acquiring section 101A may acquire the document and/or the image that has/have been detected by search. This makes it possible for a user to extremely easily understand an appealing point to a consumer of a product, service, or the like having an attribute in which the user is interested.

For example, the user who intends to develop a new healthcare product need only specify that an attribute to be analyzed is a healthcare-related product and service. This allows the data acquiring section 101A to automatically collect documents, etc. concerning various healthcare-related products and services and acquire feature data from the collected documents, etc. This makes it possible to help the user to immediately understand an appealing point to a consumer of an existing healthcare-related product and service to devise a new product, in other words, makes it possible to support decision making by the user who considers specifications, etc. of a new product.

In S12 (a data acquiring process), from one document input in S11, the data acquiring section 101A acquires, as feature data, at least one feature word or phrase that is included in the document and that indicates a feature of an analysis target. Note that, in a case where an image indicating the analysis target has been input in S11, the data acquiring section 101A generates, from the input image, a feature word or phrase indicating the feature of the analysis target, and acquires the feature word or phrase as the feature data.

In S13 (a word or phrase acquiring process), the word or phrase acquiring section 102A uses the feature data acquired in S12 to cause the language model 111A to generate an appealing word or phrase indicating a point which the analysis target appeals to a predetermined target person. Note that one appealing word or phrase may be generated for one piece of feature data (for example, one feature word or phrase), or a plurality of appealing words or phrases may be generated for one piece of feature data.

In S14, the data acquiring section 101A determines whether acquisition of a feature word or phrase and generation of an appealing word or phrase have ended for all the documents input in S11. In a case where a determination result in S14 is “NO”, the process returns to S12, and the data acquiring section 101A acquires the feature word or phrase from a document for which acquisition of the feature word or phrase has not been carried out. In contrast, in a case where the determination result in S14 is “YES”, the process proceeds to S15.

In S15, the classification section 103A classifies a plurality of appealing words or phrases in accordance with their content, the plurality of appealing words or phrases having been generated by repeatedly carrying out the processes in S12 to S14. The display control section 104A determines a representative word or phrase for each classification. Note that the process in S15 may be omitted in a case where a small number of appealing words or phrases have been generated (for example, in a case where the number of generated appealing words or phrases is not more than a predetermined lower limit).

In S16, the display control section 104A generates a graph in which (a) a node indicating each analysis target and (b) a node indicating an appealing word or phrase that has been generated for the analysis target (that has been generated by repeatedly carrying out the processes in S12 to S14) are connected by an edge. In this case, the display control section 104A regards a node corresponding to appealing words or phrases determined in S15 to fall under an identical classification as a node of a representative word or phrase representing each of the appealing words or phrases of the identical classification.

Assume, for example, that an appealing word or phrase “low price” of a certain analysis target and an appealing word or phrase of “worth more than price” of another analysis target are determined to fall under an identical classification, and a representative word or phrase of that classification is determined to be “good cost performance”. In this case, the display control section 104A causes each of nodes of appealing words or phrases associated with nodes of these analysis targets to be “good cost performance”.

In S17, the display control section 104A displays, on the display apparatus, the graph generated in S16. This ends the process of FIG. 6. Note that an acquired appealing word or phrase does not necessarily need to be presented to a user. For example, the word or phrase acquiring section 102A may store the acquired appealing word or phrase in a storage such as the storage section 11A as attribute information corresponding to the appealing word or phrase. Such attribute information can be used to, for example, classify an analysis target.

Further, in S13, the word or phrase acquiring section 102A may cause the language model 111A to select one or more of candidates for the appealing word or phrase, the one or more matching the feature data acquired in S12. In this case, since appealing words or phrases to be acquired will not be unnecessarily diverse, the process in S15 may be omitted.

Further, as described earlier, into the language model 111A, the word or phrase acquiring section 102A may input, together with the feature data, the at least one appealing phrase as the candidates, the at least one appealing phrase having been generated or selected for each analysis target included in some of a plurality of groups, the groups each including analysis targets having a shared attribute, and may cause the language model 111A to select, as the at least one appealing phrase, one or more of the input candidates, the one or more matching the feature data. This brings about not only the effect brought about by the information processing apparatus 1 but also an effect of making it possible to avoid divergence of a total number of appealing words or phrases without any need for a person to set the candidates in advance.

In a case where the above configuration is employed, it is only necessary that the processes in S11 to S14 be carried out first for a group of analysis targets for which group the candidates are to be generated and that the at least one appealing word or phrase generated in those processes be regarded as the candidates. Further, after carrying out the processes in S11 to S14 and further carrying out the process in S15, representative words or phrases determined in S15 may be regarded as the candidates. After thus determining the candidates, it is only necessary to cause the language model 111A to select, in S13, the at least one appealing word or phrase from among the candidates for the remaining analysis targets. Note that, as described earlier, for an analysis target for which no appropriate candidate exists, it is possible to cause the language model 111A to newly generate an appealing word or phrase.

### [Variation]

The processes described in the foregoing example embodiments may be carried out by any subject, which is not limited to the foregoing examples. For example, a system having functions similar to those of the information processing apparatus 1, 1A can be constructed by a plurality of apparatuses that can communicate with each other. The processes shown in the flowchart illustrated in FIG. 6 may be carried out by a single apparatus (that can be rephrased as a processor) or by a plurality of apparatuses (that can be rephrased also as processors).

### [Software Implementation Example]

Some or all of the functions of the information processing apparatus 1, 1A can be realized by hardware such as an integrated circuit (IC chip), or can be realized by software.

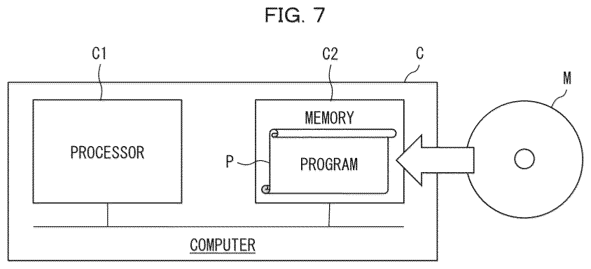

In the latter case, the information processing apparatus 1 or 1A is realized by, for example, a computer that executes instructions of a program that is software realizing the foregoing functions. FIG. 7 illustrates an example of such a computer (hereinafter referred to as “computer C”). FIG. 7 is a block diagram illustrating a hardware configuration of the computer C which functions as the information processing apparatus 1 or 1A.

The computer C includes at least one processor C1 and at least one memory C2. In the memory C2, a program (analysis program) P for causing the computer C to operate as the information processing apparatus 1 or 1A is recorded. In the computer C, the functions of the information processing apparatus 1 or 1A are realized by the processor C1 reading the program P from the memory C2 and executing the program P.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 include a flash memory, a hard disk drive (HDD), a solid state drive (SSD), and a combination thereof.

Note that the computer C may further include a random access memory (RAM) in which the program P is loaded during execution of the program P and/or in which various kinds of data are temporarily stored. The computer C may further include a communication interface via which the computer C transmits and receives data to and from another apparatus. The computer C may further include an input/output interface via which the computer C is connected to an input/output apparatus(es) such as a keyboard, a mouse, a display, and/or a printer.

The program P can be stored in a non-transitory tangible recording medium M which is readable by the computer C. Examples of the recording medium M encompass a tape, a disk, a card, a semiconductor memory, and a programmable logic circuit. The computer C can obtain the program P via the recording medium M. The program P can be transmitted via a transmission medium. Examples of the transmission medium encompass a communications network and a broadcast wave. The computer C can obtain the program P also via such a transmission medium.

The foregoing functions of the information processing apparatus 1 or 1A may be realized by a single processor provided in a single computer, may be realized by cooperation by a plurality of processors provided in a single computer, or may be realized by cooperation by a plurality of processors provided in a respective plurality of computers. A program for causing the information processing apparatus 1 or 1A to realize the foregoing functions may be stored in a single memory provided in a single computer, may be stored dispersedly in a plurality of memories provided in a single computer, or may be stored dispersedly in a plurality of memories provided in a respective plurality of computers.

### [Additional Remark 1]

The present disclosure includes techniques described in supplementary notes below. Note, however, that the present invention is not limited to the techniques described in the supplementary notes below, but may be altered in various ways by a skilled person within the scope of the claims.

### [Additional Remark A]

### (Supplementary Note A1)

An information processing apparatus including: a data acquiring means for acquiring feature data indicating a feature of an analysis target; and a word or phrase acquiring means for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.

### (Supplementary Note A2)

The information processing apparatus described in supplementary note A1, wherein the data acquiring means acquires, as the feature data, a feature word or phrase that is included in a document describing the analysis target and that indicates the feature of the analysis target, and the word or phrase acquiring means inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note A3)

The information processing apparatus described in supplementary note A1 or A2, wherein the data acquiring means generates, from an image indicating the analysis target, a feature word or phrase indicating a feature of the analysis target, and acquires the feature word or phrase as the feature data, and the word or phrase acquiring means inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note A4)

The information processing apparatus described in any one of supplementary notes A1 to A3, wherein, into the language model, the word or phrase acquiring means inputs, together with the feature data, the at least one appealing word or phrase as the candidates, the at least one appealing word or phrase having been generated or selected for each analysis target included in some of a plurality of groups, the groups each including analysis targets having a shared attribute, and causes the language model to select, as the at least one appealing word or phrase, one or more of the input candidates, the one or more matching the feature data.

### (Supplementary Note A5)

The information processing apparatus described in any one of supplementary notes A1 to A4, further including a display control means for displaying, on a display apparatus, a graph in which (a) a node indicating the analysis target and (b) a node indicating the at least one appealing word or phrase generated or selected for the analysis target are connected by an edge.

### (Supplementary Note A6)

The information processing apparatus described in supplementary note A5, further including a classification means for, in accordance with content of a plurality of appealing words or phrases that have been generated or selected and that the at least one appealing word or phrase comprises, classifying the plurality of appealing words or phrases, the display control means displaying, in each of nodes corresponding to the respective appealing words or phrases that fall under an identical classification, a representative word or phrase which represents each of the appealing words or phrases that fall under the identical classification.

### [Additional Remark B]

### (Supplementary Note B1)

An analysis method including: a data acquiring process for acquiring feature data indicating a feature of an analysis target; and a word or phrase acquiring process for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data, the data acquiring process and the word or phrase acquiring process each being carried out by at least one processor.

### (Supplementary Note B2)

The analysis method described in supplementary note B1, wherein, in the data acquiring process, the at least one processor acquires, as the feature data, a feature word or phrase that is included in a document describing the analysis target and that indicates the feature of the analysis target, and in the word or phrase acquiring process, the at least one processor inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note B3)

The analysis method described in supplementary note B1 or B2, wherein, in the data acquiring process, the at least one processor generates, from an image indicating the analysis target, a feature word or phrase indicating a feature of the analysis target, and acquires the feature word or phrase as the feature data, and in the word or phrase acquiring process, the at least one processor inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note B4)

The analysis method described in any one of supplementary notes B1 to B3, wherein, in the word or phrase acquiring process, into the language model, the at least one processor inputs, together with the feature data, the at least one appealing word or phrase as the candidates, the at least one appealing word or phrase having been generated or selected for each analysis target included in some of a plurality of groups, the groups each including analysis targets having a shared attribute, and causes the language model to select, as the at least one appealing word or phrase, one or more of the input candidates, the one or more matching the feature data.

### (Supplementary Note B5)

The analysis method described in any one of supplementary notes B1 to B4, wherein the at least one processor carries out a display control process for displaying, on a display apparatus, a graph in which (a) a node indicating the analysis target and (b) a node indicating the at least one appealing word or phrase generated or selected for the analysis target are connected by an edge.

### (Supplementary Note B6)

The analysis method described in supplementary note B5, further including a classification process for, in accordance with content of a plurality of appealing words or phrases that have been generated or selected and that the at least one appealing word or phrase comprises, classifying the plurality of appealing words or phrases, the classification process being carried out by the at least one processor, in the display control process, the at least one processor displaying, in each of nodes corresponding to the respective appealing words or phrases that fall under an identical classification, a representative word or phrase which represents each of the appealing words or phrases that 1 fall under the identical classification.

### [Additional Remark C]

### (Supplementary Note C1)

An analysis program for causing a computer to function as: a data acquiring means for acquiring feature data indicating a feature of an analysis target; and a word or phrase acquiring means for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.

### (Supplementary Note C2)

The analysis program described in supplementary note C1, wherein the data acquiring means acquires, as the feature data, a feature word or phrase that is included in a document describing the analysis target and that indicates the feature of the analysis target, and the word or phrase acquiring means inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note C3)

The analysis program described in supplementary note C1 or C2, wherein the data acquiring means generates, from an image indicating the analysis target, a feature word or phrase indicating a feature of the analysis target, and acquires the feature word or phrase as the feature data, and the word or phrase acquiring means inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note C4)

The analysis program described in any one of supplementary notes C1 to C3, wherein, into the language model, the word or phrase acquiring means inputs, together with the feature data, the at least one appealing word or phrase as the candidates, the at least one appealing word or phrase having been generated or selected for each analysis target included in some of a plurality of groups, the groups each including analysis targets having a shared attribute, and causes the language model to select, as the at least one appealing word or phrase, one or more of the input candidates, the one or more matching the feature data.

### (Supplementary Note C5)

The analysis program described in any one of supplementary notes C1 to C4, wherein the analysis program causes the computer to function as a display control means for displaying, on a display apparatus, a graph in which (a) a node indicating the analysis target and (b) a node indicating the at least one appealing word or phrase generated or selected for the analysis target are connected by an edge.

### (Supplementary Note C6)

The analysis program described in supplementary note C5, wherein the analysis program causes the computer to function as a classification means for, in accordance with content of a plurality of appealing words or phrases that have been generated or selected and that the at least one appealing word or phrase comprises, classifying the plurality of appealing words or phrases, and the display control means displays, in each of nodes corresponding to the respective appealing words or phrases that fall under an identical classification, a representative word or phrase which represents each of the appealing words or phrases that fall under the identical classification.

### [Additional Remark D]

### (Supplementary Note D1)

An information processing apparatus comprising at least one processor, the at least one processor carrying out: a data acquiring process for acquiring feature data indicating a feature of an analysis target; and a word or phrase acquiring process for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.

The information processing apparatus may further include a memory. The memory may store a program for causing the at least one processor to carry out each of the processes.

### (Supplementary Note D2)

The information processing apparatus described in supplementary note D1, wherein, in the data acquiring process, the at least one processor acquires, as the feature data, a feature word or phrase that is included in a document describing the analysis target and that indicates the feature of the analysis target, and in the word or phrase acquiring process, the at least one processor inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note D3)

The information processing apparatus described in supplementary note D1 or D2, wherein, in the data acquiring process, the at least one processor generates, from an image indicating the analysis target, a feature word or phrase indicating a feature of the analysis target, and acquires the feature word or phrase as the feature data, and in the word or phrase acquiring process, the at least one processor inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

### (Supplementary Note D4)

The information processing apparatus described in any one of supplementary notes D1 to D3, wherein, in the word or phrase acquiring process, into the language model, the at least one processor inputs, together with the feature data, the at least one appealing word or phrase as the candidates, the at least one appealing word or phrase having been generated or selected for each analysis target included in some of a plurality of groups, the groups each including analysis targets having a shared attribute, and causes the language model to select, as the at least one appealing word or phrase, one or more of the input candidates, the one or more matching the feature data.

### (Supplementary Note D5)

The information processing apparatus described in any one of supplementary notes D1 to D4, wherein the at least one processor carries out a display control process for displaying, on a display apparatus, a graph in which (a) a node indicating the analysis target and (b) a node indicating the at least one appealing word or phrase generated or selected for the analysis target are connected by an edge.

### (Supplementary Note D6)

The information processing apparatus described in supplementary note D5, wherein the at least one processor carries out a classification process for, in accordance with content of a plurality of appealing words or phrases that have been generated or selected and that the at least one appealing word or phrase comprises, classifying the plurality of appealing words or phrases, and in the display control process, the at least one processor displays, in each of nodes corresponding to the respective appealing words or phrases that fall under an identical classification, a representative word or phrase which represents each of the appealing words or phrases that fall under the identical classification.

### [Additional Remark E]

A non-transitory recording medium recording therein an analysis program for causing a computer to carry out: a data acquiring process for acquiring feature data indicating a feature of an analysis target; and a word or phrase acquiring process for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.

### REFERENCE SIGNS LIST

1 Information processing apparatus
101 Data acquiring section (data acquiring means)
102 Word or phrase acquiring section (word or phrase acquiring means)
1A Information processing apparatus
101A Data acquiring section (data acquiring means)
102A Word or phrase acquiring section (word or phrase acquiring means)
103A Classification section (classification means)
104A Display control section (display control means)
111A Language model

1. An information processing apparatus comprising at least one processor, the at least one processor carrying out:
a data acquiring process for acquiring feature data indicating a feature of an analysis target; and
a word or phrase acquiring process for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.

2. The information processing apparatus according to claim 1, wherein
in the data acquiring process, the at least one processor acquires, as the feature data, a feature word or phrase that is included in a document describing the analysis target and that indicates the feature of the analysis target, and
in the word or phrase acquiring process, the at least one processor inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

3. The information processing apparatus according to claim 1, wherein
in the data acquiring process, the at least one processor generates, from an image indicating the analysis target, a feature word or phrase indicating the feature of the analysis target, and acquires the feature word or phrase as the feature data, and
in the word or phrase acquiring process, the at least one processor inputs the feature word or phrase into the language model to cause the language model to generate the at least one appealing word or phrase, or inputs the feature word or phrase and the candidates into the language model to cause the language model to select, as the at least one appealing word or phrase, one or more of the candidates, the one or more matching the feature word or phrase.

4. The information processing apparatus according to claim 1, wherein, in the word or phrase acquiring process, into the language model, the at least one processor inputs, together with the feature data, the at least one appealing word or phrase as the candidates, the at least one appealing word or phrase having been generated or selected for each analysis target included in some of a plurality of groups, the groups each including analysis targets having a shared attribute, and causes the language model to select, as the at least one appealing word or phrase, one or more of the input candidates, the one or more matching the feature data.

5. The information processing apparatus according to claim 1, wherein the at least one processor carries out a display control process for displaying, on a display apparatus, a graph in which (a) a node indicating the analysis target and (b) a node indicating the at least one appealing word or phrase generated or selected for the analysis target are connected by an edge.

6. The information processing apparatus according to claim 5, wherein
the at least one processor carries out a classification process for, in accordance with content of a plurality of appealing words or phrases that have been generated or selected and that the at least one appealing word or phrase comprises, classifying the plurality of appealing words or phrases, and
in the display control process, the at least one processor displays, in each of nodes corresponding to the respective appealing words or phrases that fall under an identical classification, a representative word or phrase which represents each of the appealing words or phrases that fall under the identical classification.

7. An analysis method comprising:
a data acquiring process for acquiring feature data indicating a feature of an analysis target; and
a word or phrase acquiring process for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data,
the data acquiring process and the word or phrase acquiring process each being carried out by at least one processor.

8. A non-transitory computer-readable recording medium recording therein an analysis program for causing a computer to function as:
a data acquiring means for acquiring feature data indicating a feature of an analysis target; and
a word or phrase acquiring means for using the feature data to cause a language model that has been machine-learned to generate at least one appealing word or phrase indicating a point which the analysis target appeals to a predetermined target person, or for causing the language model to select one or more of candidates for the at least one appealing word or phrase, the one or more matching the feature data.
